(19) United States
(12) Patent Application Publication
(10) Pub. No.: US 2003/0182640 A1
(43) Pub. Date: Sep. 25, 2003

(54) Signal integrity analysis system

(76) Inventors: Alaa F. Alani, Hillingdon (GB); Thomas Ngo, San Jose, CA (US); Patrick M. Morrin, Bournemouth (DE)

Correspondence Address: LSI LOGIC CORPORATION, 1621 BARBER LANE, MS: D-106 LEGAL, MILPITAS, CA, 95035, US

(21) Appl. No.: 10/103,508

(22) Filed: Mar. 20, 2002

(51) Int. Cl. G06F 17/50

(52) U.S. Cl. 716/4; 716/6

(57) ABSTRACT

A method of signal integrity analysis includes providing a pre-defined circuit layout in SPICE format; selecting from a menu at least one of a technology, a driver, a driver package, a transmission line, a termination, a receiver package, a stimulus, a measurement, options, and sweep parameters for the predefined circuit layout; generating a SPICE netlist from the pre-defined circuit layout; simulating the predefined circuit layout from the SPICE netlist; and generating as output at least one of a listing, a waveform, and a signal measurement from the simulation of the pre-defined circuit layout.

### FIELD OF THE INVENTION

The present invention relates generally to methods of simulating electronic circuits. More specifically, but without limitation thereto, the present invention relates to a method of simulating a circuit to analyze signal integrity.

### BACKGROUND OF THE INVENTION

Often, engineers are required to assess or predict the quality of signals at the chip level. This type of analysis includes the prediction of signal delay, overshoot, undershoot, crosstalk effects, and simultaneous switching output (SSO) from chip designs. As the speed of digital signals increases, crosstalk, ground bounce, and power droop result in problems with off-chip signal integrity. Accordingly, a need exists for a method of analyzing off-chip signals and predicting off-chip signal quality.

### SUMMARY OF THE INVENTION

As the complexity of low level spice simulation of such circuits increases dramatically, the need for automatic generation of spice model and simulation becomes very important. This capability offers significant time saving and accuracy. The tool of the present invention plugs in these predefined, correct by construction models together in an appropriate manner to avoid any mismatch in the input/output pins of different blocks. Users are not required to be familiar with these blocks or subcircuits, neither do they need to be experts in low level simulation tools such as Spice.

In one aspect of the present invention, a method of simulating a circuit includes providing a predefined circuit layout in SPICE format; selecting from a menu at least one of a technology, a driver, a driver package, a transmission line, a termination, a receiver package, a stimulus, a measurement, options, and sweep parameters for the pre-defined circuit layout; generating a SPICE netlist from the pre-defined circuit layout; simulating the pre-defined circuit layout from the SPICE netlist; and generating as output at least one of a listing, a waveform, and a signal measurement from the simulation of the pre-defined circuit layout.

### DESCRIPTION OF THE SEVERAL VIEWS OF THE DRAWINGS

The present invention is illustrated by way of example and not limitation in the accompanying figures, in which like references indicate similar elements throughout the several views of the drawings, and in which:

FIG. 1 is a block diagram of a Signal Integrity Analysis System (SIAS) according to an embodiment of the present invention;

FIG. 2 illustrates a schematic diagram of an overall circuit model of the Signal Integrity Analysis System (SIAS) of FIG. 1;

FIG. 3 illustrates a flow chart of the steps performed by the Signal Integrity Analysis System (SIAS) of FIG. 1;

FIG. 3A illustrates examples of a tabular output, a SPICE listing output, and a waveform output generated by a computer program implementing the steps of the flow chart of FIG. 3; and

FIG. 4 illustrates the various circuit options or choices available to the user to select from.

Elements in the figures are illustrated for simplicity and clarity and have not necessarily been drawn to scale. For example, the dimensions of some of the elements in the figures may be exaggerated relative to other elements to help to improve understanding of embodiments of the present invention.

### DESCRIPTION OF THE ILLUSTRATED EMBODIMENTS

In one aspect of the present invention, a Signal Integrity Analysis System (SIAS) provides the capability of performing a prediction and analysis for off-chip signal quality as well as insight into the quality of the signals that are generated, for example, by Application Specific Integrated Circuits (ASICs) and connected to other integrated circuits on external circuit boards and systems. The Signal Integrity Analysis System is a tool that allows the designer to simulate the off-chip circuitry including the output buffer, package, board, and termination so that a signal generated by the external (off-chip) circuitry may be observed during the simulation as it propagates to the receiving buffer.

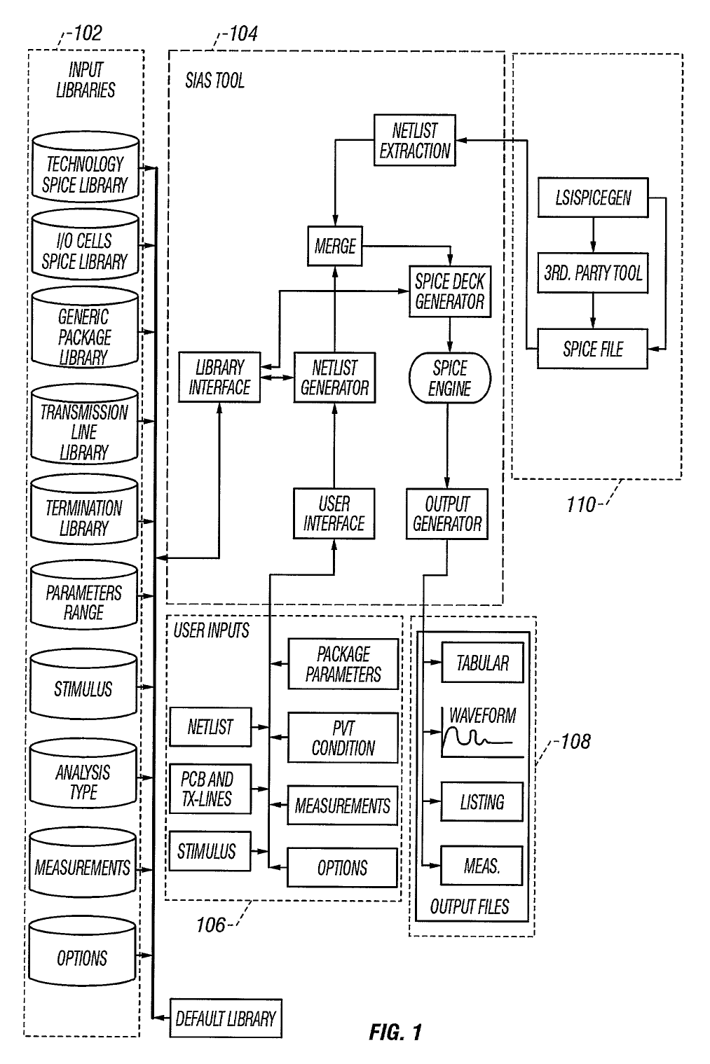

FIG. 1 illustrates a block diagram of a Signal Integrity Analysis System (SIAS) according to an embodiment of the present invention. Shown in FIG. 1 are input libraries 102, a Signal Integrity Analysis System (SIAS) tool 104, user inputs 106, output files 108, and third party tools 110.

The input libraries 102 support the Signal Integrity Analysis System tool 104 to facilitate accurate development of off-chip signal integrity analysis networks for addressing off-chip signal integrity issues in the following areas:

1) overshoot/undershoot

2) ramptime/slewrate

3) signal delay

4) signal skew

5) simultaneous switching output (SSO) noise

6) crosstalk between pins and traces

The measurements library in the input libraries 102 provides the user with measurements of signal delay, clock skew, overshoot, undershoot, ground bounce, power droop, and crosstalk in tabular form. Other libraries in the input libraries 102 provide flexibility for the Signal Integrity Analysis System (SIAS) tool 104. For example, a specific type of voltage stimulus may be selected from the stimulus library. Frequency, risetime, and other parameters may be entered from the parameters range library. The analysis type library provides the capability of selecting a DC, AC, or transient analysis.

The Signal Integrity Analysis System (SIAS) tool 104 interfaces with the input libraries 102 and the user inputs 106 to generate a SPICE netlist for a predefined circuit layout. The Signal Integrity Analysis System (SIAS) tool 104 may also interface with the third party tools 110. The Simulation Program with Integrated-Circuit Emphasis (SPICE) netlist from the third party tools 110, which models on-chip signals, may be merged with the output of the “Netlist Generator” in 104, which models off-chip signals, to generate a SPICE netlist for the overall circuit. The SPICE netlist of the overall circuit may then be simulated in the SPICE engine according to well known techniques to generate output files representative of the simulation.

The user inputs 106 may be implemented as a sequence of pull-down menus for selecting each of the variables in the pre-defined circuit layout. Examples of user inputs 106 are a netlist, that is, a user defined circuit description in SPICE or a SPICE-compatible format, a printed circuit board type, a transmission line type, a package type, process, voltage, and temperature (PVT) conditions, measurements required from the user, such as delay, ground bounce, or any subset of the measurements contained in the measurements library, and simulation options.

The output files 108 may include, for example, a tabular output containing the required user defined parameters and output results measured by the SPICE simulator, a waveform output of one or more signals in the pre-defined circuit layout, a listing output of all input and output dsata and measurements, and a measurements output including the subset of the measurements required by the user from the measurements library.

The third party tools 110 may include, for example, sub-circuits from other tools, such as three-dimension (3D) extraction tools.

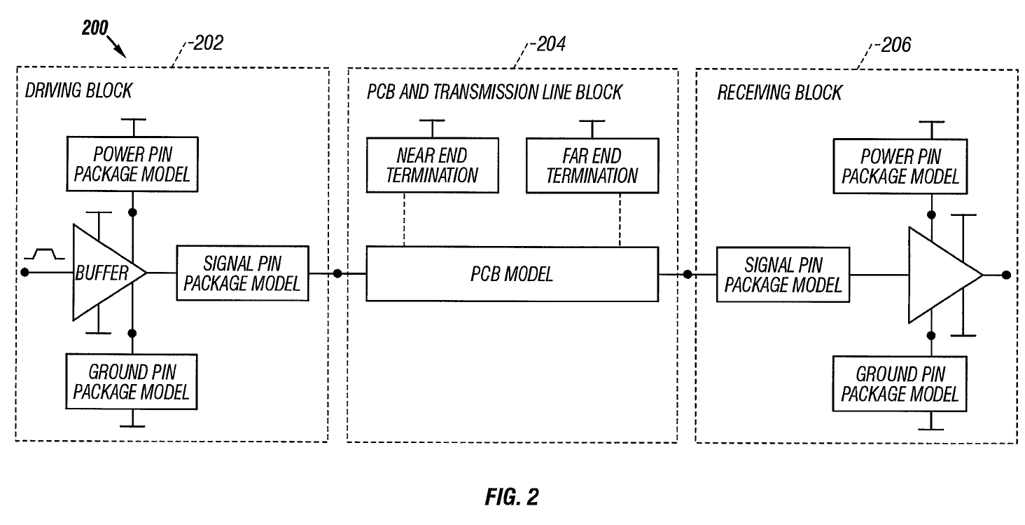

FIG. 2 illustrates a schematic diagram of an overall circuit model 200 of the Signal Integrity Analysis System (SIAS) of FIG. 1. Shown in FIG. 2 are a driving module 202, a printed circuit board (PCB) and transmission line module 204, and a receiving module 206. The Signal Integrity Analysis System (SIAS) tool 104 allows the user to select the components in each of these modules. For example, the driving buffer in the driving module 202 may be selected from a pull-down menu listing the driving buffers in the I/O cells SPICE library included in the input libraries 102. The driving buffer is automatically connected in the circuit by the driving module 202 without the user having to enter the connection instructions in SPICE format. In a similar manner, the user may select the printed circuit board (PCB) and the terminations from pull-down menus in the printed circuit board (PCB) and transmission line module 204. The user may select the package type and the receiving buffer type from pull-down menus in the receiving module 206.

An options menu allows the user to select fanout, simulation time, accuracy, disable warnings, and so on.

By providing one or more pre-defined circuit layouts as described above, the Signal Integrity Analysis System of the present invention allows circuit designers unfamiliar with SPICE syntax and format to simulate circuit operation of virtually any circuit design using the SPICE engine.

The Signal Integrity Analysis System of the present invention also provides default values for all parameters that are needed by the simulation but have not been defined by the user. This is paramount for maintaining the flexibility of Signal Integrity Analysis System and simplifying the SPICE deck generation process.

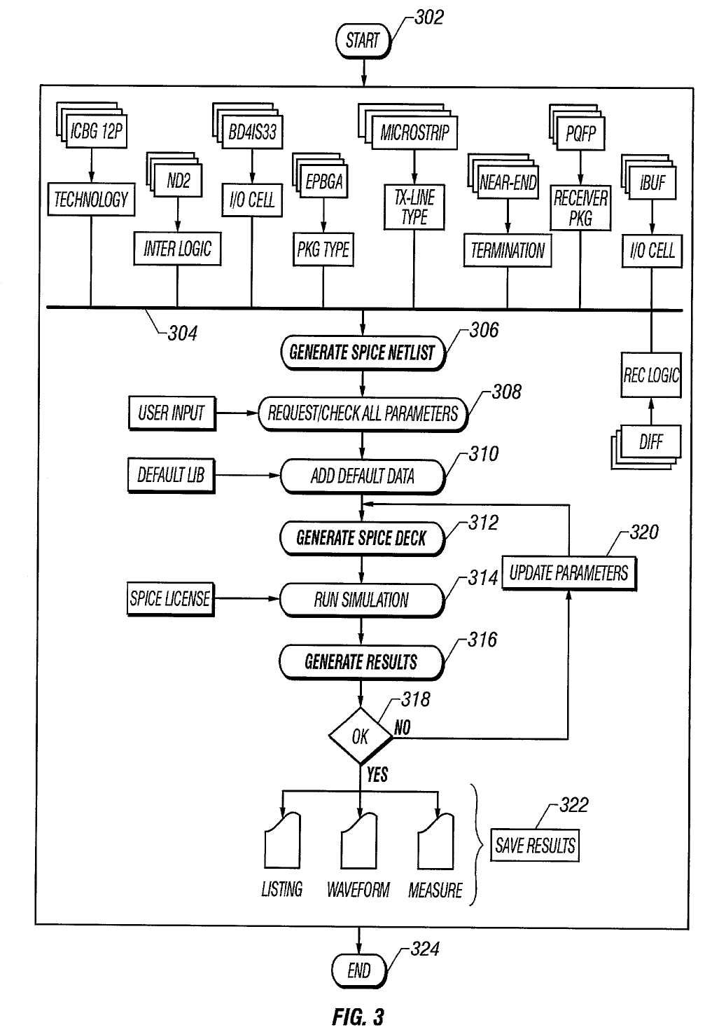

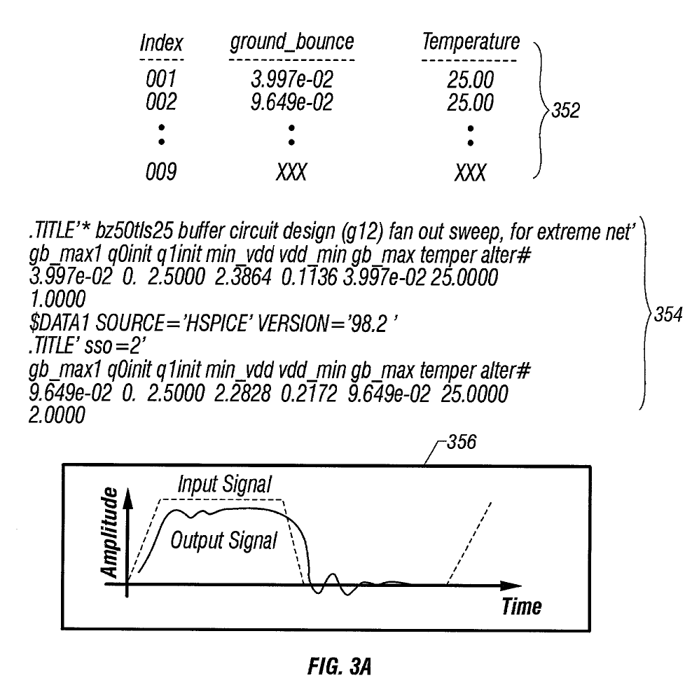

FIG. 3 illustrates a flow chart 300 of the steps performed by the Signal Integrity Analysis System (SIAS) of FIG. 1.

Step 302 is the entry point of the flow chart 300.

In step 304, the user selects the components for each of the modules in the circuit model from a series of pull-down menus.

In step 306, a SPICE netlist is generated for the circuit model according to well known techniques.

In step 308, request/check is performed to prompt the user to enter the necessary parameters specifying signal rise/fall time, sampling time, signal (stimulus) frequency, and so on.

In step 310, if any of the parameters necessary to create the SPICE deck file have not been entered, default values are supplied for the missing parameters from the default library.

In step 312, a SPICE deck (file) is generated for the overall circuit model according to standard SPICE simulation techniques.

In step 314, a simulation of the overall circuit model is performed in a standard SPICE engine.

In step 316, the results of the simulation are generated.

In step 318, if the results of the simulation are satisfactory, control transfers to step 322. Otherwise, control transfers to step 320.

In step 320, one or more of the user defined parameters may be changed to investigate the effect on the simulation results.

In step 322, the results are saved as output in a convenient tabular output, a SPICE listing output, a waveform output, and a tabular measurements output. Examples of a tabular measurements output, a listing output, and a waveform output are illustrated in FIG. 3A.

Step 324 is the exit point for the flow chart 300.

FIG. 3A illustrates examples of a tabular output 352, a SPICE listing output 354, and a waveform output 356 generated by a computer program implementing the steps of the flow chart of FIG. 3 for a buffer circuit design.

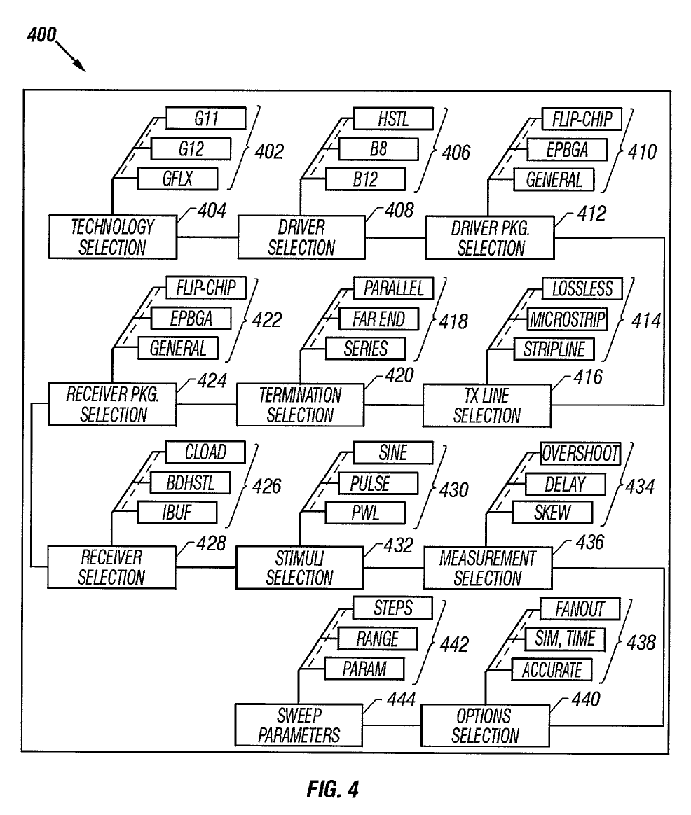

FIG. 4 illustrates the various circuit options or choices available to the user to select from. For example, transmission line types 416 that are supported in the tool include lossless, microstrip and stripline from which the user may select one that reflects the board trace used in the design. Shown in FIG. 4 are technology pull-down menus 402, a technology selection entry 404, driver pull-down menus 406, a driver selection entry 408, driver package pull-down menus 410, a driver package selection entry 412, transmission line pull-down menus 414, a transmission line selection entry 416, termination pull-down menus 418, a termination selection entry 420, receiver package pull-down menus 422, a receiver package entry 424, receiver pull-down menus 426, a receiver selection entry 428, stimuli pull-down menus 430, a stimuli selection entry 432, measurement pull-down menus 434, a measurement selection entry 436, options pull-down menus 438, an options selection entry 440, sweep parameters pull-down menus 442, and a sweep parameters selection entry 444.

The pull-down menus select the appropriate entries from the input libraries 102 in FIG. 1 for step 304 of FIG. 3. The user selects a desired technology from the technology pull-down menus 402, for example, 0.18 microns or 0.13 microns. The desired technology is stored in the technology selection entry 404. The user selects an output buffer from the list of available drivers provided in the I/O Cells SPICE library of the input libraries 102 from the driver pull-down menus 406. The selected output buffer is stored in the driver selection entry 408. The user selects a driver package from the driver package pull-down menus 410, for example, flip-chip, enhanced plastic ball grid array (EPBGA), or any other package type. The selected package type is stored in the driver package selection entry 412. The user selects a transmission line from the transmission line pull-down menus 414, for example, lossless, microstrip, or stripline. The selected transmission line type is stored in the transmission line selection entry 416. The user selects a termination and the desired placement of the termination from the termination pull-down menus 418, for example, parallel, far end (that is, termination at the far end of the transmission line on the printed circuit board in block 204 near the receiver in block 206 of FIG. 2), or series. The selected termination is stored in the termination selection entry 420. The user selects a receiver package from the receiver package pull-down menus 422, for example, flip-chip, EPBGA, or any other type of package. The receiver package type is stored in the receiver package entry 424. The user selects a receiver from the receiver pull-down menus 426, for example, SDRAM, PCI receiver, or any other chip on the circuit model 200 in FIG. 2. The selected receiver is stored in the receiver selection entry 428. The user selects a voltage type from the stimuli pull-down menus 430, for example, a sine wave, a pulse, or a piecewise linear signal (PWL), such as a square wave, a triangular wave, a trapezoidal wave, and so on. The selected voltage stimulus is stored in the stimuli selection entry 432. The user selects a measurement to be performed from the measurement pull-down menus 434, for example, overshoot, delay, or skew. The selected measurement is stored in the measurement selection entry 436. The user selects options from the options pull-down menus 438, for example, fanout, normal or speed-up simulation time, disabling of warnings, and required accuracy. The selected options are stored in the options selection entry 440. The user selects sweep parameters from the sweep parameters pull-down menus 442, for example, the number of time steps for increasing or decreasing the granularity or resolution of the simulation, the parameters to be swept, and the range, that is, the minimum and maximum value between which each parameter is to be swept or varied. For example, a minimum frequency of 50 MHz and a maximum frequency of 150 MHz may be selected to sweep the signal frequency over a range of 100 MHz. If the time step is 100 nsec, then the simulation is repeated 10 times. Also, the user may wish to simulate operation of the overall circuit at different frequencies and various parasitic inductances, resistances, and capacitances of different chip packages. A simulation may be performed for each combination of frequency type and package parasitics selected by the user. The selected sweep parameters are stored in the sweep parameters selection entry 444. The Signal Integrity Analysis System of the present invention provides default values for all parameters involved in the simulation so that they can be used when the user is unable to define these parameters. For example, board-level parameters may not be known to a typical ASIC designer, yet these parameters have to be defined before any simulation can run. Therefore, it is quite important that the tool provides a default value for each of the parameters that have not been defined by the users in order to facilitate the simulation. These default values are usually average values.

In a preferred embodiment, the Signal Integrity Analysis System generates a low-level SPICE deck generation for a simulation engine based on Avant! Star SPICE. The Signal Integrity Analysis System tool also allows the use of high accuracy SPICE (HSPICE) models without having to familiarize the user with how they work. The method of the present invention does not require that the user be familiar with package or board level models or have experience with SPICE simulation to perform the desired analysis. The present invention uses the SPICE model, which is more accurate for simulating transmission lines with I/O buffers than models such as the I/O Buffer Information Specification (IBIS) model. Also, an extensive set of libraries in SPICE format has already been developed which may be used to practice the present invention.

Because a pre-defined circuit layout is used, the user is not required to place the components for the simulation. Alternatively, the user may be presented with several pre-defined circuit layouts to choose from. For example, a pre-defined circuit layout may allow the user to specify the type of transmission line along with dimensions, the type of termination, chip package parasitics, number of switching buffers, and so on. The utilization of a pre-defined circuit layout for the signal integrity analysis saves time in setting up the simulation and avoids the error-prone process of manually editing text in a SPICE deck for each simulation. Also, on-chip SPICE files may be combined with off-chip SPICE files to more accurately simulate overall circuit behavior. Driving buffers may be simulated with different chip packages to resolve signal integrity problems that may be rectified by changing the buffer type or chip package.

Although the simulated circuit architecture is fixed, the circuit topology, i.e., component placement, is flexible. Subcircuits may be customized by defining parameters of the board, package, and so on. Either library SPICE models and/or user-supplied SPICE models such as the SPICE file in the third party tools 110 of FIG. 1 may be used with the Signal Integrity Analysis System of the present invention.

Although the flowchart examples described above have been shown with reference to specific steps performed in a specific order, these steps may be combined, sub-divided, or reordered in other embodiments without departing from the scope of the claims. Except as specifically indicated herein, the order and grouping of steps is not a limitation of the present invention.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

What is claimed is:

1. A method of signal integrity analysis comprising:
providing a pre-defined circuit layout in SPICE format having selectable components;
selecting components of the pre-defined circuit layout from a user interface;
automatically generating a SPICE netlist from the pre-defined circuit layout for the selected components;
generating a SPICE deck from the SPICE netlist;
simulating the pre-defined circuit layout from the SPICE netlist in a SPICE engine; and
generating at least one of a tabular output, a listing output, a waveform output, and a measurement output from the simulation of the pre-defined circuit layout.

2. The method of claim 1 further comprising merging the SPICE netlist of the pre-defined circuit layout with a SPICE netlist of a third party tool.

3. The method of claim 1 wherein selecting the components comprises selecting from a menu at least one of a technology, a driver, a driver package, a transmission line, a termination, a receiver package, a stimulus, a measurement, options, and sweep parameters.

4. The method of claim 1 further comprising providing default values for all parameters required for simulating the pre-defined circuit layout that are not selected from the user interface.

5. The method of claim 1 further comprising generating the SPICE netlist of the pre-defined circuit layout from input libraries.

6. The method of claim 5 wherein the input libraries comprise at least one of a technology SPICE library, an I/O cells SPICE library, a generic package library, a transmission line library, a termination library, a parameters range library, a stimulus library, an analysis type library, a measurements library, and an options library.

7. A system of signal integrity analysis comprising:
a pre-defined circuit layout in SPICE format having selectable components;
a user interface for selecting the components of the pre-defined circuit layout;
a netlist generator for automatically generating a SPICE netlist from the pre-defined circuit layout for the selected components;
a SPICE deck generator for generating a SPICE deck from the SPICE netlist;
a SPICE engine for simulating the pre-defined circuit layout from the SPICE netlist; and
an output generator for generating at least one of a tabular output, a listing output, a waveform output, and a measurement output from the simulation of the predefined circuit layout.

8. The system of claim 7 further comprising a third party tool for generating an on-chip circuit netlist for merging with the SPICE netlist of the predefined circuit layout.

9. The system of claim 7 wherein the user interface comprises a menu for selecting at least one of a technology, a driver, a driver package, a transmission line, a termination, a receiver package, a stimulus, a measurement, options, and sweep parameters.

10. The system of claim 7 further comprising default values for all parameters required for simulating the pre-defined circuit layout that are not selected from the user interface.

11. The system of claim 7 further comprising input libraries for generating the SPICE netlist of the pre-defined circuit layout.

12. The system of claim 9 wherein the input libraries comprise at least one of a technology SPICE library, an I/O cells SPICE library, a generic package library, a transmission line library, a termination library, a parameters range library, a stimulus library, an analysis type library, a measurements library, and an options library.
